(19) United States
(12) Patent Application Publication
(10) Pub. No.: US 2026/0222578 A1
(43) Pub. Date: Jul. 30, 2026

(54) IMAGE PROCESSING METHOD AND COMPUTING DEVICE

(71) Applicant: CLOUD INTELLIGENCE ASSETS HOLDING (SINGAPORE) PRIVATE LIMITED, Singapore (SG)

(72) Inventors: Wei TIAN, Shanghai (CN); Hongbo MIN, Shanghai (CN)

(21) Appl. No.: 19/147,083

(22) PCT Filed: Jan. 10, 2024
(86) PCT No.: PCT/CN2024/071643

§ 371 Date: Jul. 10, 2025

(30) Foreign Application Priority Data
Jan. 10, 2023 (CN) 202310033112.6

(51) Int. Cl. H04N 19/136; H04N 19/119; H04N 19/172; H04N 19/176; H04N 19/42

(52) U.S. Cl. CPC H04N 19/136; H04N 19/119; H04N 19/172; H04N 19/176; H04N 19/42

(57) ABSTRACT

An image processing method and a computing device are provided. At least one first image block in a first image frame whose content changes compared to a second image frame is determined; a graphics processing unit is invoked to calculate a first feature of the at least one first image block; a content type of the at least one first image block is determined based on the first feature of the at least one first image block; the graphics processing unit is invoked to compress the at least one first image block according to compression manners corresponding to different content types; update information for the first image frame is generated based on the at least one first image block that is compressed, and the update information is transmitted to a receiving end; the update information being used to obtain the first image frame in combination with the second image frame.

### CROSS-REFERENCE TO RELATED APPLICATION

The present application is a National Stage of International Application No. PCT/CN2024/071643, filed on Jan. 10, 2024, which claims priority to Chinese patent application No. 202310033112.6, filed with the China National Intellectual Property Administration on Jan. 10, 2023 and entitled “IMAGE PROCESSING METHOD AND COMPUTING DEVICE”. These applications are hereby incorporated by reference in their entireties.

### TECHNICAL FIELD

Embodiments of the present application relate to the technology field of image transmission and, in particular, to an image processing method and a computing device.

### BACKGROUND

In some application scenarios involving image stream transmission, to improve image transmission efficiency, it is common to perform compression-based transmission on image frames, so as to reduce the amount of transmission. However, even with the compression-based transmission, the amount of data transmitted remains relatively large, and thus the transmission efficiency is not high and the resulted CPU overhead is significant, which affects the CPU performance.

### SUMMARY

Embodiments of the present application provide an image processing method and a computing device to address the technical problem in the prior art that the image transmission efficiency is low, affecting the CPU performance.

In a first aspect, an embodiment of the present application provides an image processing method, including:
determining at least one first image block in a first image frame whose content changes compared to a second image frame;
invoking a graphics processing unit to calculate a first feature of the at least one first image block;
determining a content type of the at least one first image block based on the first feature of the at least one first image block;
invoking the graphics processing unit to compress the at least one first image block according to compression manners corresponding to different content types;
generating update information for the first image frame based on the at least one first image block that is compressed, and transmitting the update information to a receiving end; where the update information is used to obtain the first image frame in combination with the second image frame.

In a second aspect, an embodiment of the present application provides an image processing method, including:
determining at least one first image block in a first image frame whose content changes compared to a second image frame; where the first image frame is outputted by a cloud computing product, and the cloud computing product includes a cloud desktop or a cloud application;
invoking a graphics processing unit to calculate a first feature of the at least one first image block;
determining a content type of the at least one first image block based on the first feature of the at least one first image block;
invoking the graphics processing unit to compress the at least one first image block according to compression manners corresponding to different content types;
generating update information for the first image frame based on the at least one first image block that is compressed, and transmitting the update information to a local client corresponding to the cloud computing product; where the update information is used to obtain the first image frame in combination with the second image frame.

In a third aspect, an embodiment of the present application provides an image processing method, including:
determining a plurality of first image blocks obtained by dividing a first image frame;
invoking a graphics processing unit to calculate second features of the plurality of first image blocks;
determining at least one of the first image blocks in the first image frame whose content changes compared to a second image frame, based on the second features;
generating update information for the first image frame based on the at least one of the first image blocks, and transmitting the update information to a receiving end; where the update information is used to obtain the first image frame in combination with the second image frame.

In a fourth aspect, an embodiment of the present application provides an image processing method, including:
calculating a first feature of at least one first image block in a first image frame based on a first invocation instruction; where the first invocation instruction is sent by a sending end after the sending end determines the at least one first image block in the first image frame whose content changes compared to a second image frame;
feeding back the first feature of the at least one first image block to the sending end; where the first feature of the at least one first image block is used to determine a content type of the at least one first image block, and generate a corresponding compression instruction;
compressing the at least one first image block according to a compression manner indicated by the compression instruction;
sending the at least one image block that is compressed to the sending end; where the at least one image block that is compressed is used to generate update information for the first image frame and transmit the update information to a receiving end, and the update information is used to obtain the first image frame in combination with the second image frame.

In a fifth aspect, an embodiment of the present application provides an image processing method, where the method is applied to a graphics processing unit configured in a physical device running a cloud computing product, and the cloud computing product includes a cloud desktop or a cloud application; the method includes:
calculating a first feature of at least one first image block in a first image frame outputted by the cloud computing product, based on a first invocation instruction; where the first invocation instruction is sent by the cloud computing product after the cloud computing product determines the at least one first image block in the first image frame whose content changes compared to a second image frame;
feeding back the first feature of the at least one first image block to the cloud computing product; where the first feature of the at least one first image block is used to determine a content type of the at least one first image block, and generate a corresponding compression instruction;
compressing the at least one first image block according to a compression manner indicated by the compression instruction;
sending the at least one image block that is compressed to the cloud computing product; where the at least one image block that is compressed is used to generate update information for the first image frame and transmit the update information to a local receiving end corresponding to the cloud computing product, and the update information is used to obtain the first image frame in combination with the second image frame.

In a sixth aspect, an embodiment of the present application provides a computing device, including a processing component and a storage component; where the processing component includes a central processing unit and a graphics processing unit;
the storage component stores one or more computer instructions;
the central processing unit is configured to invoke and execute at least one computer instruction to implement the image processing method as described in the first aspect or the second aspect or the third aspect mentioned above;
the graphics processing unit is configured to invoke and execute at least one computer instruction to implement the image processing method as described in the fourth aspect or the fifth aspect mentioned above.

In a seventh aspect, an embodiment of the present application provides a computer storage medium storing a computer program, and when the computer program is executed by a computer, the image processing method as described in the first aspect or the second aspect or the third aspect mentioned above is implemented, or the image processing method as described in the fourth aspect or the fifth aspect mentioned above is implemented.

In the embodiments of the present application, by comparing a first image frame with a second image frame, at least one first image block in the first image frame whose content changes is determined; a graphics processing unit is invoked to calculate a first feature of the at least one first image block; a content type of the at least one first image block is determined based on the first feature of the at least one first image block; the graphics processing unit is invoked to compress the at least one first image block according to compression manners corresponding to different content types; update information for the first image frame is generated based on the at least one first image block that is compressed, and the update information is transmitted to a receiving end; where the update information is used to obtain the first image frame in combination with the second image frame. In the embodiments of the present application, the graphics processing unit is utilized for computational processing and, by comparing with the second image frame, only the update information generated based on the at least one first image block that is compressed is transmitted, and the receiving end can restore the first image frame in combination with the second image frame, without the need to transmit the complete image frame, thereby reducing the amount of data transmitted. Additionally, different compression manners are used for different content types, which ensures the image transmission quality while reducing the data transmission volume, thus improving the image transmission efficiency and being able to reduce the CPU overhead and enhance the CPU performance.

These and other aspects of the present application will become more apparent and easier to understand in the following description of the embodiments.

### BRIEF DESCRIPTION OF DRAWINGS

To describe the technical solutions in the embodiments of the present application or in the prior art more clearly, the drawings used in the description of the embodiments or the prior art will be briefly introduced in the following. Obviously, the drawings in the following description are some embodiments of the present application, and for those of ordinary skill in the art, other drawings can be obtained based on these drawings without creative effort.

FIG. 1 shows a flowchart of an embodiment of an image processing method provided in the present application.

FIG. 2 shows a flowchart of another embodiment of an image processing method provided in the present application.

FIG. 3 shows a flowchart of another embodiment of an image processing method provided in the present application.

FIG. 4 shows a flowchart of another embodiment of an image processing method provided in the present application.

FIG. 5 shows a schematic diagram of a system architecture applicable to an actual application of an embodiment of the present application.

FIG. 6 shows a flowchart of another embodiment of an image processing method provided in the present application.

FIG. 7 shows a schematic structural diagram of an embodiment of an image processing apparatus provided in the present application.

FIG. 8 shows a schematic structural diagram of an embodiment of an image processing apparatus provided in the present application.

FIG. 9 shows a schematic structural diagram of an embodiment of an image processing apparatus provided in the present application.

FIG. 10 shows a schematic structural diagram of an embodiment of an image processing apparatus provided in the present application.

FIG. 11 shows a schematic structural diagram of an embodiment of a computing device provided in the present application.

FIG. 12 shows a schematic structural diagram of an embodiment of an electronic device provided in the present application.

### DESCRIPTION OF EMBODIMENTS

To enable those skilled in the art to better understand the solutions of the present application, the technical solutions in the embodiments of the present application will be described clearly and comprehensively in the following with reference to the accompanying drawings.

In some processes described in the description and claims as well as the above-mentioned drawings of the present application, multiple operations that appear in a specific order are included. However, it should be understood that these operations may not be performed in the order in which they appear herein or performed in parallel. The sequence numbers of the operations, such as 101, 102, etc., are only used to distinguish different operations, and the sequence numbers themselves do not represent any execution order. In addition, these processes may include more or fewer operations, and these operations may be performed sequentially or in parallel. It should be noted that the descriptions such as “first”, “second” herein are used to distinguish different messages, devices, modules, etc., and do not represent a sequence or limit that “first” and “second” are of different types.

The technical solutions of the embodiments of the present application may be applied to any scenario where a sending end performs image stream transmission to a receiving end. In an actual application, for example, an image transmission scenario of a cloud computing product may be applied to.

To improve image transmission efficiency, reduce CPU (central processing unit) overhead, and enhance CPU performance, the inventors proposed the technical solutions of the embodiments of the present application after a series of studies. Through the technical solutions of the embodiments of the present application, a GPU (graphics processing unit) is invoked for computational processing, and a CPU is responsible for logic processing. By performing image analysis on a first image frame and a second image frame, there is no need to transmit a complete image frame, thereby reducing the amount of data transmitted, improving the image transmission efficiency, and being able to reduce the CPU overhead and enhance the CPU performance.

In the following, the technical solutions in the embodiments of the present application will be described clearly and comprehensively with reference to the accompanying drawings. Obviously, the described embodiments are only a part of the embodiments of the present application, rather than all the embodiments. Based on the embodiments of the present application, all other embodiments obtained by those of ordinary skill in the art without creative effort shall fall within the scope of protection of the present application.

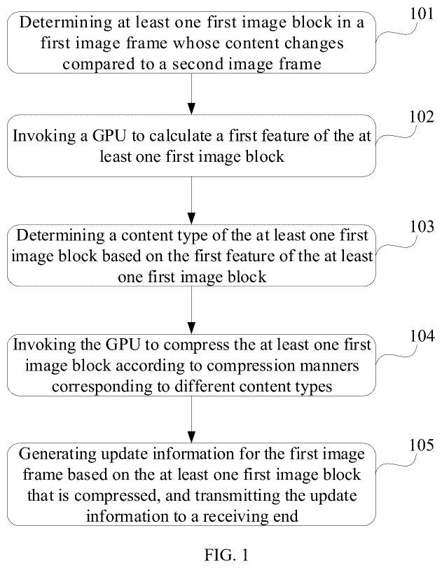

FIG. 1 is a flowchart of an embodiment of an image processing method provided in an embodiment of the present application. The technical solution of this embodiment may be executed by a sending end. Since the sending end runs in a CPU of a physical device, the technical solution may actually be executed specifically by the CPU corresponding to the sending end. The method may include the following steps.
101, determining at least one first image block in a first image frame whose content changes compared to a second image frame.

The second image frame is a reference image frame. In an actual application, since a content change between adjacent image frames is usually considered to be small, the second image frame may be the previous frame of the first image frame. Of course, other implementations are also possible. For example, the second image frame may also be an image frame separated from the first image frame by several frames or a preset image frame, etc.

In this embodiment, the first image frame is first compared with the second image frame to determine at least one first image block whose content has changed.

The first image frame and the second image frame may be divided into a plurality of image blocks in the same division manner, and an image block whose content has changed may be determined by comparing image blocks. For ease of description, herein, the image blocks corresponding to the first image frame are named first image blocks, and the image blocks corresponding to the second image frame are named second image blocks.
102, invoking a GPU to calculate a first feature of the at least one first image block.

Here, the first feature may be an image feature that represents the image content, such as a color feature, etc.

There are multiple implementations to calculate the color feature. As an implementation, the color feature may be the number of color types in the image block. Specifically in execution, for any unprocessed pixel point in any first image block, whether its pixel value is a newly added value may be determined. If yes, the quantity of new additions is accumulated; if no, it may proceed to the next pixel point for determination. If the accumulated quantity of new additions is greater than a quantity threshold or there is no unprocessed pixel point, the accumulated quantity of new additions may be used as the first feature.

Of course, the color feature may also be implemented in other ways, such as a color histogram, a color aggregation vector, a color correlogram, etc., which is not limited in the present application.
103, determining a content type of the at least one first image block based on the first feature of the at least one first image block.

To improve computational efficiency, in the embodiment of the present application, the GPU may be invoked for computational processing, so as to calculate the first feature of the at least one first image block.

In an implementation, the parallel computing capability of the GPU may be utilized. The GPU is invoked to calculate the first feature of the at least one first image block in parallel to improve the computational efficiency. For example, the CUDA (Compute Unified Device Architecture) capability of the GPU may be utilized to calculate respective first features corresponding to the plurality of first image blocks in parallel.

The respective first feature of the at least one first image block obtained by calculation by the GPU may be fed back to the CPU, so that the CPU may be utilized to determine the content type based on the first feature of each first image block.

Here, the content type may include, for example, an image type or a text type, and the image type may be further divided into a simple image type and a complex image type. For example, it may be that when the first feature is less than a text feature threshold, the image content carried by the image block is determined to be of the text type; when the first feature is greater than the text feature threshold and less than an image feature threshold, the image content carried by the image block is determined to be of the simple image type; when the first feature is greater than the image feature threshold, the image content carried by the image block is determined to be of the complex image type; where the text feature threshold is less than the image feature threshold.
104, invoking the GPU to compress the at least one first image block according to compression manners corresponding to different content types.

In the embodiment of the present application, the content type corresponding to each first image block is determined, then the GPU may be invoked to compress the first image block according to the compression manner corresponding to the content type. For example, a lossy compression manner may be used for the text type, a lossless compression manner may be used for the image type, and so on, to ensure the image quality while reducing the data transmission volume, etc.

In an implementation, in the case that a plurality of first image blocks are included, the GPU may be invoked to compress the plurality of first image blocks in parallel to improve the computational efficiency, etc.
105, generating update information for the first image frame based on the at least one first image block that is compressed, and transmitting the update information to a receiving end.

Here, the update information is used to obtain the first image frame in combination with the second image frame.

The update information may include information of the at least one first image block that is compressed, so that only the image area where the content has changed may be transmitted. The receiving end may obtain the at least one first image block by decompression, and may restore and obtain the first image frame in combination with the second image frame.

In this embodiment, the GPU is invoked for computational processing, and the CPU is responsible for logic processing. By performing image analysis on the first image frame and the second image frame, there is no need to transmit the complete image frame, thereby reducing the amount of data transmitted, improving the image transmission efficiency, and being able to reduce the CPU overhead and enhance the CPU performance.

In some embodiments, the method may further include: determining a plurality of first image blocks obtained by dividing the first image frame; invoking the GPU to calculate second features of the plurality of first image blocks respectively; where the first image frame may be divided into the plurality of first image blocks according to a preset image block size.

Then the determining at least one first image block in the first image frame whose content changes compared to the second image frame may include: determining at least one first image block in the first image frame whose content changes compared to the second image frame, based on the second features.

As an implementation, the second feature may be a hash feature obtained by calculation using an image hash algorithm. The image hash algorithm may include, for example, a difference hash algorithm, an average hash algorithm, a perceptual hash algorithm, a wavelet hash algorithm, etc., which is not limited in the present application. By using the hash feature, image comparison can be performed quickly and conveniently, so as to improve the image processing efficiency.

In some embodiments, the sending end may output image frames in real time, and the determining the plurality of first image blocks obtained by dividing the first image frame may include:
invoking the GPU to capture the first image frame that is currently outputted; where the second image frame is the previous frame of the first image frame;
determining a division manner of the first image frame based on image resolution of the first image frame, and notifying the GPU of the division manner;
then the invoking the GPU to calculate the second features of the plurality of first image blocks may include: invoking the GPU to divide the first image frame into the plurality of first image blocks according to the division manner, and calculate the second features of the plurality of first image blocks.

In the embodiments of the present application, the GPU may capture the image frame. At this time, there is no need to transmit the image frame to the CPU, and the CPU can determine how to divide the first image frame based on the image resolution of the first image frame and notify the GPU of the division manner. For ease of understanding, a division manner is illustrated exemplarily in the following. It should be noted that the present application is not limited thereto:

$$block\_width = ( pic\_width + mbSize - 1 ) / mbSize ;$$

$$block\_height = ( pic\_height + mbSize - 1 ) / mbSize ;$$

where the image resolution may be formed by the width pic_width and the height pic_height of the first image frame; the preset image block size may be mbSize*mbSize; block_width represents the number of image blocks in the horizontal direction obtained by division, and block_height represents the number of image blocks in the vertical direction obtained by division.

Here, the image resolution of the first image frame may be recognized by the GPU and fed back to the CPU, or may be preset, which is not limited in the present application.

In some embodiments, the determining at least one first image block in the first image frame whose content changes compared to the second image frame may include:
for any first image block in the first image frame, comparing the first image block with a corresponding second image block at a same position in the second image frame;
in a case of content being the same, determining that the first image block is of a content-unchanged type;
in a case of the content being different, if there is a second image block in the second image frame whose content is same as that of the first image block, determining that the first image block is of a position-updated type, and determining position change information of the first image block;
if there is no second image block in the second image frame whose content is same as that of the first image block, determining that the first image block is of a content-changed type;
determining at least one first image block of the content-changed type in the first image frame;
then the generating the update information for the first image frame based on the at least one first image block that is compressed may include:
generating the update information for the first image frame based on identification information of an image block of the content-unchanged type, position change information of an image block of the position-updated type, and the at least one first image block that is compressed.

Here, whether the content is the same may be obtained by comparison in combination with the second features. If the second features are the same, the content may be considered the same; if the second features are different, the content may be considered different.

Here, the update information may specifically include the identification information of the image block of the content-unchanged type, the position change information of the image block of the position-updated type, and the information of the at least one first image block that is compressed, so that a corresponding image block may be found from the second image frame based on the identification information, and a corresponding image block may also be found based on the position change information. In combination with the at least one first image block obtained after decompression, the first image frame may be restored and obtained.

The position change information may include a position difference between the first image block and the second image block, identification information of the first image block, and identification information of the second image block, etc. Here, the identification information may be represented by using position coordinates, or by using the second feature, or by using a combination of the position coordinates and the second feature, etc., which is not limited in the present application. In addition to including the information of the at least one first image block that is compressed, the update information may further include identification information of the at least one first image block, so as to facilitate locating the at least one first image block, etc. In an actual application, the sending end may refer to a cloud computing product, and the receiving end is a local client corresponding to the cloud computing product. Therefore, in this actual application scenario, the determining at least one first image block in the first image frame whose content changes compared to the second image frame may include: determining a plurality of first image blocks obtained by dividing the first image frame outputted by the cloud computing product; determining at least one first image block in the first image frame whose content changes compared to the second image frame; where the second image frame is the previous frame of the first image frame.

The transmitting the update information to the receiving end may be: transmitting the update information to the local client corresponding to the cloud computing product.

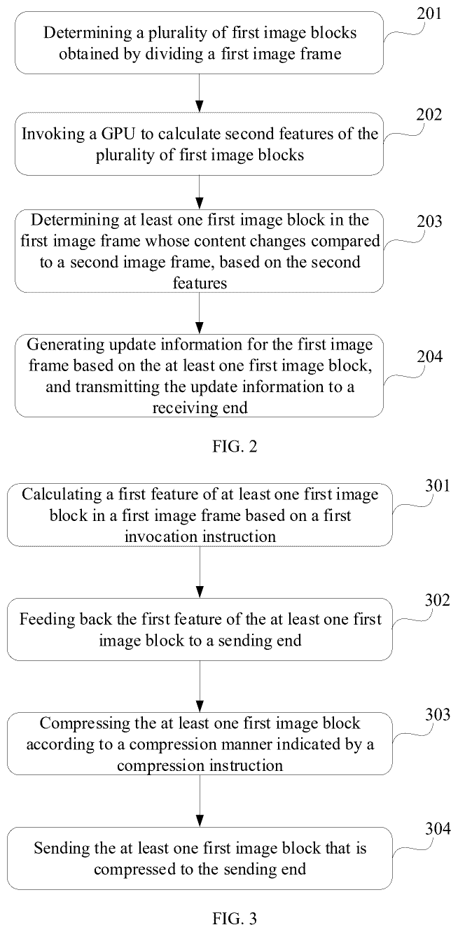

FIG. 2 is a flowchart of another embodiment of an image processing method provided in an embodiment of the present application. The technical solution of this embodiment may be executed by a sending end. Since the sending end runs in a CPU of a physical device, the technical solution may actually be executed specifically by the CPU corresponding to the sending end. The method may include the following steps.
201, determining a plurality of first image blocks obtained by dividing a first image frame.

The first image frame may be divided into a plurality of first image blocks according to a preset image block size.
202, invoking a GPU to calculate second features of the plurality of first image blocks.

To improve computational efficiency, in the embodiment of the present application, the GPU may be invoked for computational processing, so as to calculate the second feature of the at least one first image block.

In an implementation, the parallel computing capability of the GPU may be utilized. The GPU is invoked to calculate the second features of the plurality of first image blocks in parallel to improve the computational efficiency. For example, the CUDA (Compute Unified Device Architecture) capability of the GPU may be utilized to calculate the respective second features corresponding to the plurality of first image blocks in parallel.

The second feature may be a hash feature obtained by calculation using an image hash algorithm. The image hash algorithm may include, for example, a difference hash algorithm, an average hash algorithm, a perceptual hash algorithm, a wavelet hash algorithm, etc., which is not limited in the present application. By using the hash feature, image comparison can be performed quickly and conveniently, so as to improve the image processing efficiency.
203, determining at least one first image block in the first image frame whose content changes compared to a second image frame, based on the second features.

Here, the first image frame and the second image frame may be divided into a plurality of image blocks in the same division manner. The first image block whose content has changed may be determined by comparing image blocks, specifically by comparing whether the second features corresponding to two image blocks are the same. Using the second features for comparison can improve the processing efficiency.
204, generating update information for the first image frame based on the at least one first image block, and transmitting the update information to a receiving end.

Here, the update information is used to obtain the first image frame in combination with the second image frame.

Here, the update information may include information of the at least one first image block, so that only the image area where the content has changed may be transmitted. The receiving end may restore and obtain the first image frame based on the at least one first image block and in combination with the second image frame.

In this embodiment, the GPU is invoked for computational processing, and the CPU is responsible for logic processing. By calculating the second features of the first image frame, and performing image analysis on the first image frame and the second image frame based on the second features, there is no need to transmit the complete image frame, thereby reducing the amount of data transmitted, improving the image transmission efficiency, and being able to reduce the CPU overhead and enhance the CPU performance.

In some embodiments, since the sending end outputs image frames in real time, the determining the plurality of first image blocks obtained by dividing the first image frame may include:
invoking the GPU to capture the first image frame that is currently outputted; where the second image frame is the previous frame of the first image frame;
determining, based on image resolution of the first image frame, a division manner of dividing the first image frame into the plurality of first image blocks, and notifying the GPU of the division manner;
the invoking the GPU to calculate the second features of the plurality of first image blocks may include: invoking the GPU to divide the first image frame into the plurality of first image blocks according to the division manner, and calculate the second features of the plurality of first image blocks.

In the embodiments of the present application, the GPU may capture the image frame. At this time, there is no need to transmit the image frame to the CPU, and the CPU can determine how to divide the first image frame based on the image resolution of the first image frame and notify the GPU of the division manner. For the division manner, reference can be made to the detailed description of the embodiments shown in FIG. 1, which will not be repeated here.

Here, the image resolution of the first image frame may be recognized by the GPU and fed back to the CPU, or may be preset, which is not limited in the present application.

In some embodiments, to further reduce the amount of data transmitted and improve the image transmission efficiency and the like, the generating the update information for the first image frame based on the at least one first image block may include: invoking the GPU to calculate a first feature of the at least one first image block; determining a content type of the at least one first image block based on the first feature of the at least one first image block; invoking the GPU to compress the at least one first image block according to compression manners corresponding to different content types; generating the update information for the first image frame based on the at least one first image block that is compressed, and transmitting the update information to a receiving end; where the update information is used to obtain the first image frame in combination with the second image frame.

Here, the first feature may be an image feature that represents the image content, such as a color feature, etc.

The respective first feature of the at least one first image block obtained by calculation by the GPU may be fed back to the CPU, so that the CPU may be utilized to determine the content type based on the first feature of each first image block.

Here, the content type may include, for example, an image type or a text type, and the image type may be further divided into a simple image type and a complex image type. For example, it may be that when the first feature is less than a text feature threshold, the image content carried by the image block is determined to be of the text type; when the first feature is greater than the text feature threshold and less than an image feature threshold, the image content carried by the image block is determined to be of the simple image type; when the first feature is greater than the image feature threshold, the image content carried by the image block is determined to be of the complex image type; where the text feature threshold is less than the image feature threshold.

Here, after determining the content type corresponding to each first image block, the GPU may be invoked to compress the first image block according to the compression manner corresponding to the content type. For example, a lossy compression manner may be used for the text type, and a lossless compression manner may be used for the image type, and so on, to ensure the image quality while reducing the data transmission volume, etc.

In an implementation, in the case that a plurality of first image blocks are included, the GPU may be invoked to compress the plurality of first image blocks in parallel to improve the computational efficiency, etc.

The update information may specifically include information of the at least one first image block that is compressed, so that only the image area where the content has changed may be transmitted. The receiving end may obtain the at least one first image block by decompression and may restore and obtain the first image frame in combination with the second image frame.

In some embodiments, the determining at least one first image block in the first image frame whose content changes compared to the second image frame based on the second features may include:
for any first image block in the first image frame, comparing a second feature of the first image block with a second feature corresponding to a second image block at a same position in the second image frame;
in a case of being the same, determining that the first image block is of a content-unchanged type;
in a case of being different, if there is a second image block in the second image frame whose second feature is same as that of the first image block, determining that the first image block is of a position-updated type, and determining position change information of the first image block;
if there is no second image block in the second image frame whose second feature is same as that of the first image block, determining that the first image block is of a content-changed type;
determining at least one first image block of the content-changed type in the first image frame;
the generating the update information for the first image frame based on the at least one first image block may include:
generating the update information for the first image frame based on identification information of an image block of the content-unchanged type, position change information of an image block of the position-updated type, and the at least one first image block.

The update information may specifically include the identification information of the image block of the content-unchanged type, the position change information of the image block of the position-updated type, and the information of the at least one first image block. In the case that the at least one first image block is compressed, the update information may specifically include the information of the at least one first image block that is compressed. The receiving end may find a corresponding image block from the second image frame based on the identification information and may also find a corresponding image block based on the position change information, and then the first image frame may be restored and obtained in combination with the at least one first image block obtained after decompression.

FIG. 3 is a flowchart of another embodiment of an image processing method provided in an embodiment of the present application. The technical solution of this embodiment may be executed by a GPU in a physical device running a sending end. The sending end specifically runs in a CPU of the physical device. The method may include the following steps.
301, calculating a first feature of at least one first image block in a first image frame based on a first invocation instruction.

Here, the first invocation instruction may be sent by a sending end after the sending end determines the at least one first image block in the first image frame whose content changes compared to a second image frame.

A parallel computing manner may be used to calculate the first feature of the at least one first image block in the first image frame.
302, feeding back the first feature of the at least one first image block to the sending end.

Here, the first feature of the at least one first image block is used to determine a content type of the at least one first image block, and generate a corresponding compression instruction.
303, compressing the at least one first image block according to a compression manner indicated by the compression instruction.

In the case that a plurality of first image blocks are included, the plurality of first image blocks may be compressed in parallel. The compression instruction may include a respective compression manner corresponding to the at least one first image block, so that the at least one first image block may be compressed according to the respective compression manner.
304, sending the at least one image block that is compressed to the sending end.

Here, the at least one image block that is compressed is used to generate update information for the first image frame and transmit the update information to a receiving end, and the update information is used to obtain the first image frame in combination with the second image frame.

In some embodiments, the method may further include: calculating, based on a second invocation instruction, second features of the plurality of first image blocks obtained by dividing the first image frame;
feeding back the second features of the plurality of first image blocks to the sending end; where the second features of the plurality of first image blocks are used to determine the at least one first image block in the first image frame whose content changes compared to the second image frame.

The second invocation instruction may be sent by the sending end.

In some embodiments, the method may further include:
capturing the first image frame that is currently outputted; where the second image frame may be a previous frame of the first image frame;
dividing the first image frame into the plurality of first image blocks based on a division manner sent by the sending end.

The capturing the first image frame that is currently outputted may be performed in response to the second invocation instruction, and of course, it may also be performed based on a capture instruction sent by the sending end, or may be performed autonomously. The GPU may divide the first image frame into the plurality of first image blocks and send a completion notification to the sending end, and then the sending end may send the second invocation instruction to trigger the calculation of the second features.

In addition, after capturing the first image frame that is currently outputted, image resolution may be fed back to the sending end. The sending end may determine a division manner corresponding to the first image frame based on the image resolution, and then feed back the division manner to the GPU, which may then divide the first image frame accordingly.

As another embodiment, the present application further provides an image processing method executed by a GPU, which may include the following steps:
calculating second features of a plurality of first image blocks obtained by dividing a first image frame, based on an invocation instruction;
feeding back the second features of the plurality of first image blocks to a sending end; where the second features of the plurality of first image blocks are used to determine at least one first image block in the first image frame whose content changes compared to a second image frame.

The sending end is configured to generate update information for the first image frame based on the at least one first image block and transmit the update information to a receiving end; where the update information is used to obtain the first image frame in combination with the second image frame.

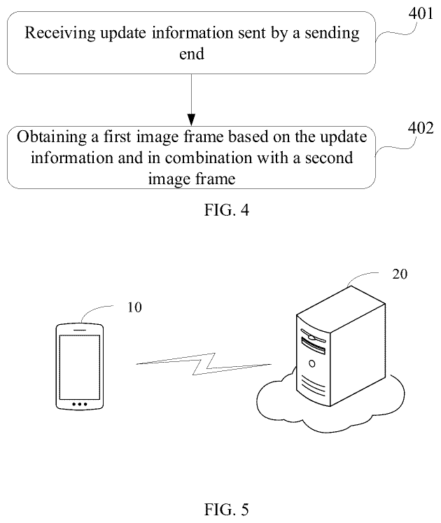

FIG. 4 is a flowchart of another embodiment of an image processing method provided in the present application. The technical solution of this embodiment may be executed by a receiving end. The method may include the following steps:
401, receiving update information sent by a sending end;
402, obtaining a first image frame based on the update information and in combination with a second image frame.

As an implementation, the update information may be generated based on at least one first image block that is compressed; the at least one first image block is compressed according to a compression manner corresponding to a respective content type; the content type of the at least one first image block is determined based on a first feature of the at least one first image block; the at least one first image block is an image block in the first image frame whose content changes compared to the second image frame; the first feature of the at least one first image block is calculated by a GPU invoked by the sending end.

In an implementation, the update information may include: identification information of an image block of a content-unchanged type, position change information of an image block of a position-updated type, and information of the at least one first image block that is compressed, so that a corresponding image block may be found from the second image frame based on the identification information, and a corresponding image block may also be found from the second image frame based on the position change information. In combination with the at least one first image block obtained after decompression, the first image frame may be restored and obtained

The position change information may include a position difference between a first image block and a second image block, identification information of the first image block, and identification information of the second image block, etc. Here, the identification information may be represented by using position coordinates, or by using a second feature, or by using a combination of position coordinates and the second feature, etc., which is not limited in the present application. In addition to including the information of the at least one first image block that is compressed, the update information may further include identification information of the at least one first image block, so as to locate the at least one first image block, etc.

As another implementation, the update information may be generated based on at least one first image block; the at least one first image block is an image block in the first image frame which is determined based on second features and whose content changes compared to the second image frame; the second features are calculated by the GPU invoked by the sending end.

In an implementation, the update information may include identification information of an image block of a content-unchanged type, position change information of an image block of a position-updated type, and information of the at least one first image block, so that a corresponding image block may be found from the second image frame based on the identification information, and a corresponding image block may also be found from the second image frame based on the position change information. In combination with the at least one first image block, the first image frame may be restored and obtained.

The position change information may include a position difference between a first image block and a second image block, identification information of the first image block, and identification information of the second image block, etc. Here, the identification information may be represented by using position coordinates, or by using a second feature, or by using a combination of position coordinates and the second feature, etc., which is not limited in the present application. In addition to including the information of the at least one first image block, the update information may further include identification information of the at least one first image blocks, so as to locate the at least one first image block, etc.

In an actual application, as mentioned before, the technical solutions of the embodiments of the present application may be applied to a cloud computing scenario, where a sending end is a cloud computing product and a receiving end is a local client. Therefore, in the cloud computing scenario, as another embodiment, the present application further provides an image processing method executed by a cloud computing product. Since the cloud computing product runs in a CPU of a physical device, the method may actually be executed specifically by the CPU corresponding to the cloud computing product. The physical device may be a physical host or the like provided by a cloud computing provider. The method may include:
determining at least one first image block in a first image frame whose content has changed compared to a second image frame, where the first image frame is outputted by the cloud computing product;
invoking a graphics processing unit to calculate a first feature of the at least one first image block;
determining a content type of the at least one first image block based on the first feature of the at least one first image block;
invoking the graphics processing unit to compress the at least one first image block according to compression manners corresponding to different content types;
generating update information for the first image frame based on the at least one first image block that is compressed, and transmitting the update information to a local client corresponding to the cloud computing product; where the update information is used to obtain the first image frame in combination with the second image frame.

As another embodiment, the present application further provides an image processing method executed by a cloud computing product. Since the cloud computing product runs in a CPU of a physical device, the method may actually be executed specifically by the CPU corresponding to the cloud computing product. The method may include:
determining a plurality of first image blocks obtained by dividing a first image frame outputted by the cloud computing product;
invoking a graphics processing unit to calculate second features of the plurality of first image blocks;
determining at least one first image block in the first image frame whose content changes compared to a second image frame, based on the second features;
generating update information for the first image frame based on the at least one first image block, and transmitting the update information to a local client corresponding to the cloud computing product; where the update information is used to obtain the first image frame in combination with the second image frame

As another embodiment, the present application further provides an image processing method executed by a GPU in a physical device running a cloud computing product. The cloud computing product specifically runs in a CPU of the physical device. The method may include:
calculating a first feature of at least one first image block in a first image frame outputted by the cloud computing product, based on a first invocation instruction;
where the first invocation instruction is sent by the cloud computing product after the cloud computing product determines the at least one first image block in the first image frame whose content changes compared to a second image frame;
feeding back the first feature of the at least one first image block to the cloud computing product; where the first feature of the at least one first image block is used to determine a content type of the at least one first image block, and generate a corresponding compression instruction;
compressing the at least one first image block according to a compression manner indicated by the compression instruction;
sending the at least one image block that is compressed to the cloud computing product; where the at least one image block that is compressed is used to generate update information for the first image frame and transmit the update information to a local client corresponding to the cloud computing product, and the update information is used to obtain the first image frame in combination with the second image frame.

As another embodiment, the present application further provides an image processing method executed by a local client corresponding to a cloud computing product. The method may include:
receiving update information sent by the cloud computing product;
obtaining a first image frame based on the update information and in combination with a second image frame.

It should be noted that the same or similar steps in the aforementioned embodiments corresponding to the cloud computing scenario can be found in the embodiments shown in FIG. 1, FIG. 2, FIG. 3, or FIG. 4, and will not be repeated here.

Here, cloud computing is one of the fastest-growing trends in computer technology, and involves the provision of hosting services over the network. The cloud computing environment provides computing and storage resources as services to end-users. The end-users may send requests to the provided services for processing. The processing capabilities of the services are usually limited by the configured resources.

It should be understood that although a detailed description about cloud computing is included in the present application, the implementation of the teachings described herein is not limited to the cloud computing environment. Instead, the embodiments of the present application may be implemented in conjunction with any other type of computing environment that is now known or developed in the future.

Cloud computing is a service delivery model, aiming at enabling on-demand network access to a shared pool of configurable computing resources (e.g., networks, network bandwidth, servers, processing, memory, storage, applications, virtual machines, and services), and these resources can be rapidly allocated and released with minimal management effort or interaction with a service provider.

The aforementioned cloud computing product is a cloud computing service provided by a cloud computing provider, and is used to achieve slimming down a terminal device. The program product that originally runs on the terminal device and mainly relies on the computing power of the terminal device is implemented by the cloud computing product configured on a server end. At the terminal device, a thin client (also known as a host end or a local client) may be used to access the cloud computing product. The cloud computing product streams the generated images to the local client in real-time, and the local client only needs to display the images. The cloud computing product involved in the embodiments of the present application may include a cloud desktop or a cloud application, etc.

Here, the cloud desktop, also known as desktop virtualization or a cloud computer, is a new model that replaces traditional computers. After adopting a cloud desktop, a user no longer needs to purchase a computer host. Components such as CPU, memory, and hard disks included in the host are all virtualized on a backend server. At the terminal device, a thin client (also known as a host end or a local client) may be used to connect to a display, a keyboard, and/or a mouse. After installing the local client, the user may access the cloud desktop on the server end through a specific communication protocol. The cloud desktop compresses and encodes a desktop image before transmitting it to the local client, and the local client only needs to display the desktop image to achieve interactive operations, realizing an experience effect consistent with that of a computer. At the same time, the cloud desktop not only supports replacing traditional computers but also supports other smart devices such as mobile phones and tablets to access over the Internet, which is the latest solution for mobile office.

Here, the cloud application is the embodiment of cloud computing technology at an application layer. Compared to a locally installed application, the cloud application has advantages of no need for download and installation, immediate use, low requirements for device capabilities, cross-platform capabilities, and so on. Cloudifying applications is becoming a future development trend. The cloud application streams the generated multimedia content (including images) to the local client in real time, and the local client only needs to display the multimedia content to achieve the purpose of smooth use of the cloud application. The interactive operations between the user and the terminal device are also handled by the cloud application.

A cloud computing product may be created for a user according to the user's request, and the user may also revoke or rebuild a cloud computing product of the same type. The user refers to a tenant, who may purchase resources of a cloud computing provider to build a cloud computing product that meets his/her needs, etc. The user may register a user account with the cloud computing provider, and the cloud computing provider distinguishes different users through user accounts.

In the cloud computing scenario, the technical solutions of the embodiments of the present application may be applied to a cloud computing system as shown in FIG. 5. The cloud computing system may include a local client 10 and a cloud server end 20.

The local client 10 may be installed in an electronic device. The electronic device may refer to a computer device that is used by a user and has functions required by the user, such as computing, Internet access, communication, etc. For example, the electronic device may be a mobile phone, a tablet, a personal computer, a wearable device, etc. The electronic device may usually include at least one processing component and at least one storage component. The electronic device may further include basic configurations such as a network card chip, an IO bus, audio and video components, etc., which is not limited in the present application. In an implementation, according to the implementation form of the electronic device, some peripheral devices may further be included, such as a keyboard, a mouse, an input pen, a printer, etc.

In practical applications, the local client 10 may be implemented, for example, as a player, or the like, and correspond to a cloud computing product, to achieve the purpose of outputting and displaying multimedia content generated by the cloud computing product.

The cloud server end 20 may deploy and run the cloud computing product. The cloud server end 20 may be a single server or a cloud-based server array, or may be a virtual machine (VM) running on a cloud-based server array, such as a container, etc. Of course, the cloud server end 20 may also refer to other computing devices with corresponding service capabilities, etc.

Here, the cloud server end 20 may deploy one or more cloud computing products, which is not limited in the present application. In the embodiments of the present application, the operating system to which the cloud computing product is applicable is not limited. In some embodiments, the cloud computing product may be a Linux system program, a Windows system program, an Android system program, or an iOS system program, etc. Besides, the operating system installed on the electronic device where the local client 10 is located may be different from the operating system to which the cloud computing product is applicable, achieving the decoupling of the operating systems of the cloud computing product and the local client.

Here, the cloud server end 20 may be a physical host or a virtual machine built on a physical host. In the case of the cloud server end 20 being a virtual machine, the operating system of the physical host where it is located may be different from the operating system of the cloud server end 20. For example, in a practical application, the physical host may be chosen as an X86 or ARM (Advanced RISC (Reduced Instruction Set Computing) Machine) server, which has virtualization capability and can support running of multiple virtual machines simultaneously, and the virtual machines may be an Android system. Since the local client does not need to be adapted to the cloud computing product, a lower-cost operating system may be chosen for it, such as Linux system or RTOS system, etc.

Here, the local client 10 and the cloud server end 20 may be connected wirelessly or in wires. In an implementation, the cloud server end 20 may communicatively connected with the local client 10 through a mobile network. Accordingly, the network standard of the mobile network may be any one of 2G (GSM (Global System for Mobile Communications)), 2.5G (GPRS (General Packet Radio Service)), 3G (WCDMA (Wideband Code Division Multiple Access), TD-SCDMA (Time Division-Synchronous Code Division Multiple Access), CDMA2000 (Code Division Multiple Access 2000), UMTS (Universal Mobile Telecommunications System)), 4G (LTE (Long-Term Evolution)), 4G+ (LTE+), 5G, WiMAX (Worldwide Interoperability for Microwave Access), etc.

Here, the physical host corresponding to the cloud server end 20 may be configured with a CPU and a GPU, and the cloud computing product runs on the CPU.

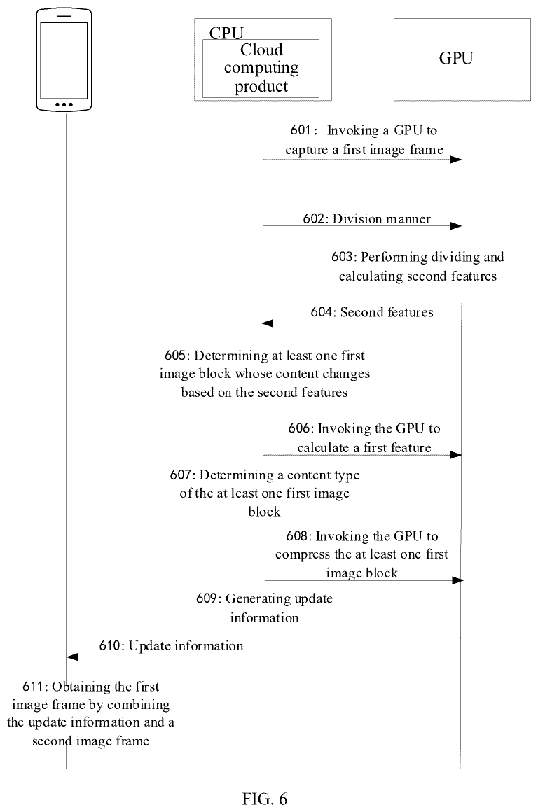

The following takes the cloud computing scenario as an example to explain the technical solutions of the embodiments of the present application. FIG. 6 shows a flowchart of another embodiment of an image processing method provided in an embodiment of the present application. The method may include the following steps.
601, a cloud computing product invokes a GPU to capture a first image frame that is currently outputted.

The cloud computing product may send a capture instruction to the GPU, and the GPU may execute the capture instruction to capture the first image frame that is currently outputted by the cloud computing product.

Here, when the cloud computing product is a cloud desktop, the first image frame is a cloud desktop image, and when the cloud computing product is a cloud application, the first image frame is the display content of the cloud application.
602, the cloud computing product determines a division manner of the first image frame, and feeds back the division manner to the GPU.
603, the GPU divides the first image frame into a plurality of first image blocks according to the division manner, and calculates respective second features corresponding to the plurality of first image blocks in parallel.

The GPU may calculate the respective second features corresponding to the plurality of first image blocks in parallel based on a second invocation instruction sent by the cloud computing product.
604, the GPU feeds back the respective second features corresponding to the plurality of first image blocks to the cloud computing product.
605, the cloud computing product determines at least one first image block in the first image frame whose content changes compared to a second image frame, based on the second features.

In an implementation, the second image frame may be the previous frame of the first image frame.
606, the cloud computing product invokes the GPU to calculate a respective first feature corresponding to the at least one first image block.

The cloud computing product may send a first invocation instruction to the GPU, and the GPU may calculate the respective first feature corresponding to the at least one first image block in parallel in response to the first invocation instruction and may feed back the respective first feature corresponding to the at least one first image block to the cloud computing product.
607, the cloud computing product determines a content type of the at least one first image block based on the first feature of the at least one first image block.
608, the cloud computing product invokes the GPU to compress the at least one first image block according to compression manners corresponding to different content types.

The cloud computing product may send a compression instruction to the GPU, and the compression instruction may include the respective compression manner corresponding to the at least one image block, so that the GPU may compress the at least one image block in parallel according to the respective compression manner thereof in response to the compression instruction. After capturing the first image frame, the GPU may save the first image frame in the GPU, which cannot be copied to the CPU. After compressing the at least one image block, the GPU may feed back the at least one first image block that is compressed to the CPU. Since the amount of data transmitted is reduced after compression, the transmission efficiency can be ensured.
609, the cloud computing product generates update information for the first image frame based on the at least one first image block that is compressed.
610, the cloud computing product transmits the update information to a local client.
611, the local client obtains the first image frame by combining the update information and the second image frame.

In the embodiment of the present application, the characteristics of the CPU and GPU are utilized to analyze the image change information and the content type of the updated area with high accuracy and precision based on the image blocks, thereby optimizing the delay, saving the CPU computing resources, achieving a heterogeneous architecture for the cloud computing product outputting images, and improving the image transmission efficiency.

FIG. 7 is a schematic structural diagram of an embodiment of an image processing apparatus provided in an embodiment of the present application. The apparatus may include:
a first determination module 701, configured to determine at least one first image block in a first image frame whose content changes compared to a second image frame;
a first invocation module 702, configured to invoke a GPU to calculate a first feature of the at least one first image block;
a second determination module 703, configured to determine a content type of the at least one first image block based on the first feature of the at least one first image block;
a compression trigger module 704, configured to invoke the GPU to compress the at least one first image block according to compression manners corresponding to different content types;
a first transmission module 705, configured to generate update information for the first image frame based on the at least one first image block that is compressed and transmit the update information to a receiving end; where the update information is used to obtain the first image frame in combination with the second image frame.

In some embodiments, the apparatus may further include:
a second invocation module, configured to: determine a plurality of first image blocks obtained by dividing the first image frame; invoke the GPU to calculate second features of the plurality of first image blocks;
where the first determination module may be specifically configured to determine the at least one first image block in the first image frame whose content changes compared to the second image frame, based on the second features.

In some embodiments, when determining the plurality of first image blocks obtained by dividing the first target image frame, the second invocation module is configured to:
invoke the GPU to capture the first image frame that is currently outputted; where the second image frame is a previous frame of the first image frame; determine a division manner of the first image frame based on image resolution of the first image frame, and notify the GPU of the division manner;
then when invoking the GPU to calculate the second features of the plurality of first image blocks, the second invocation module is configured to: invoke the GPU to divide the first image frame into the plurality of first image blocks according to the division manner, and calculate the second features of the plurality of first image blocks.

In some embodiments, the first determination module may be specifically configured to: for any first image block in the first image frame, compare the first image block with a corresponding second image block at a same position in the second image frame;
in a case of content being the same, determine that the first image block is of a content-unchanged type;
in a case of the content being different, if there is a second image block in the second image frame whose content is same as that of the first image block, determine that the first image block is of a position-updated type, and determine position change information of the first image block;
if there is no second image block in the second image frame whose content is same as that of the first image block, determine that the first image block is of a content-changed type;
determine at least one first image block of the content-changed type in the first image frame;
then when generating the update information for the first image frame based on the at least one first image block that is compressed, the first transmission module is configured to: generate the update information for the first image frame based on identification information of an image block of the content-unchanged type, position change information of an image block of the position-updated type, and the at least one first image block that is compressed.

In some embodiments, the first determination module may be specifically configured to determine the plurality of first image blocks obtained by dividing the first image frame that is outputted by a cloud computing product, and determine the at least one first image block in the first image frame whose content changes compared to the second image frame; where the second image frame is the previous frame of the first image frame;
and when transmitting the update information to the receiving end, the first transmission module is configured to: transmit the update information to a local client corresponding to the cloud computing product.

The image processing apparatus illustrated in FIG. 7 can perform the image processing method described in the embodiment shown in FIG. 1, and the implementation principle and technical effects thereof will not be repeated. The specific manners in which the modules and units of the image processing apparatus in the above embodiments perform operations have been described in detail in the embodiments related to the method, and will not be described in detail here.

FIG. 8 is a schematic structural diagram of another embodiment of an image processing apparatus provided in an embodiment of the present application. The apparatus may include:
a third invocation module 801, configured to: determine a plurality of first image blocks obtained by dividing a first image frame; invoke a GPU to calculate second features of the plurality of first image blocks;
a third determination module 802, configured to determine at least one first image block in the first image frame whose content changes compared to a second image frame, based on the second features;
a second transmission module 803, configured to: generate update information for the first image frame based on the at least one first image block, and transmit the update information to a receiving end; where the update information is used to obtain the first image frame in combination with the second image frame.

In some embodiments, when determining the plurality of first image blocks obtained by dividing the first target image frame, the third invocation module is configured to: invoke the GPU to capture the first image frame that is currently outputted, where the second image frame is a previous frame of the first image frame; determine a division manner of the first image frame based on image resolution of the first image frame, and notify the GPU of the division manner; invoke the GPU to divide the first image frame into the plurality of first image blocks according to the division manner, and calculate the second features of the plurality of first image blocks in parallel.

In some embodiments, when generating the update information for the first image frame based on the at least one first image block, the second transmission module is configured to: invoke the GPU to calculate a first feature of the at least one first image block; determine a content type of the at least one first image block based on the first feature of the at least one first image block; invoke the GPU to compress the at least one first image block according to compression manners corresponding to different content types; generate the update information for the first image frame based on the at least one first image block that is compressed, and transmit the update information to a receiving end; where the update information is used to obtain the first image frame in combination with the second image frame.

In some embodiments, the third determination module may be specifically configured to: for any first image block in the first image frame, compare a second feature of the first image block with a second feature corresponding to a second image block at a same position in the second image frame; in a case of being the same, determine that the first image block is of a content-unchanged type; in a case of being different, if there is a second image block in the second image frame whose second feature is same as that of the first image block, determine that the first image block is of a position-updated type, and determine position change information of the first image block; if there is no second image block in the second image frame whose second feature is same as that of the first image block, determine that the first image block is of a content-changed type; determine at least one first image block of the content-changed type in the first image frame;
then when generating the update information for the first image frame based on the at least one first image block, the second transmission module may be configured to: generate the update information for the first image frame based on identification information of an image block of the content-unchanged type, position change information of an image block of the position-updated type, and the at least one first image block.

The image processing apparatus illustrated in FIG. 8 can perform the image processing method described in the embodiment shown in FIG. 2, and the implementation principle and technical effects thereof will not be repeated. The specific manners in which the modules and units of the image processing apparatus in the above embodiments perform operations have been described in detail in the embodiments related to the method, and will not be described in detail here.

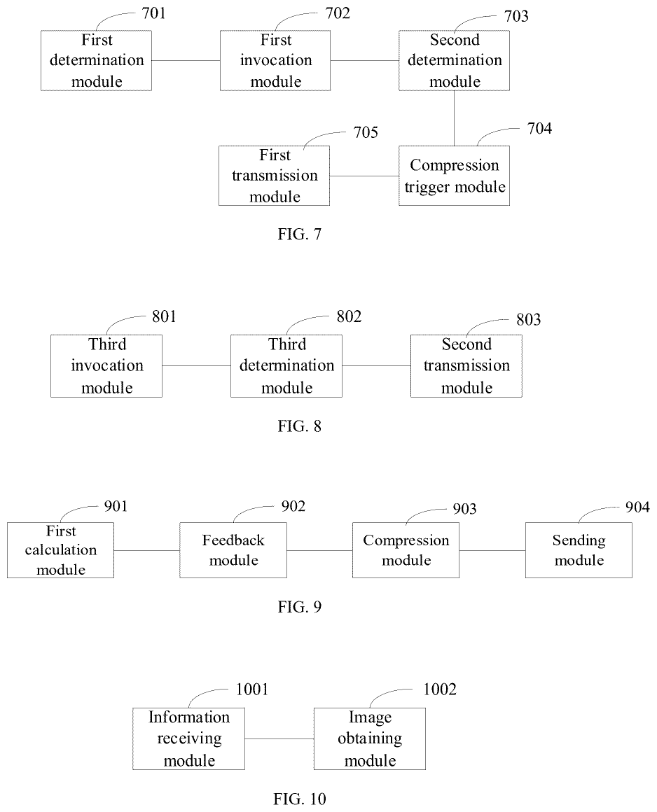

FIG. 9 is a schematic structural diagram of another embodiment of an image processing apparatus provided in an embodiment of the present application. The apparatus may include:
a first calculation module 901, configured to calculate a first feature of at least one first image block in a first image frame based on a first invocation instruction; where the first invocation instruction is sent by a CPU after the CPU determines the at least one first image block in the first image frame whose content changes compared to a second image frame;
a feedback module 902, configured to feed back the first feature of the at least one first image block to a sending end; where the first feature of the at least one first image block is used to determine a content type of the at least one first image block, and generate a corresponding compression instruction;
a compression module 903, configured to compress the at least one first image block according to a compression manner indicated by the compression instruction;
a sending module 904, configured to send the at least one image block that is compressed to the sending end; where the at least one image block that is compressed is used to generate update information for the first image frame and transmit the update information to a receiving end, and the update information is used to obtain the first image frame in combination with the second image frame.

In some embodiments, the apparatus may further include:
a second calculation module, configured to: calculate second features of a plurality of first image blocks obtained by dividing the first image frame, based on a second invocation instruction; feed back the second features of the plurality of first image blocks to the sending end; where the second features of the plurality of first image blocks are used to determine the at least one first image block in the first image frame whose content changes compared to the second image frame.

The image processing apparatus illustrated in FIG. 9 can perform the image processing method described in the embodiment shown in FIG. 3, and the implementation principle and technical effects thereof will not be repeated. The specific manners in which the modules and units of the image processing apparatus in the above embodiments perform operations have been described in detail in the embodiments related to the method, and will not be described in detail here.

FIG. 10 is a schematic structural diagram of another embodiment of an image processing apparatus provided in an embodiment of the present application. The apparatus may include:
an information receiving module 1001, configured to receive update information sent by a sending end; where the update information is generated based on at least one first image block that is compressed; the at least one image block is compressed according to a compression manner corresponding to a respective content type; the content type of the at least one first image block is determined based on a first feature of the at least one first image block; the at least one first image block is an image block in a first image frame whose content changes compared to a second image frame; the first feature of the at least one first image block is calculated by invoking a GPU;
an image obtaining module 1002, configured to obtain the first image frame based on the update information and in combination with the second image frame.

The image processing apparatus illustrated in FIG. 10 can perform the image processing method described in the embodiment shown in FIG. 4, and the implementation principle and technical effects thereof will not be repeated. The specific manners in which the modules and units of the image processing apparatus in the above embodiments perform operations have been described in detail in the embodiments related to the method, and will not be described in detail here.

An embodiment of the present application further provides a computing device, as shown in FIG. 11. The computing device may include a storage component 1101 and a processing component 1102. The processing component 1102 may include a CPU 1103 and a GPU 1104.

The storage component 1101 stores one or more computer instructions, where the CPU 1103 invokes and executes at least one of the computer instructions to implement the image processing method of the embodiment shown in FIG. 1 or the image processing method of the embodiment shown in FIG. 2, and the GPU 1104 invokes and executes at least one of the computer instructions to implement the image processing method of the embodiment shown in FIG. 3.

Of course, the computing device may further necessarily include other components, such as an input/output interface, a display component, a communication component, etc. The input/output interface provides an interface between the processing component and a peripheral interface module. The peripheral interface module may be an output device, an input device, etc. The communication component is configured to facilitate wired or wireless communication between the computing device and other devices, etc.

The storage component is configured to store data of various types to support operations on a terminal. The storage component may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

It should be noted that when the above computing device implements the image processing method shown in FIG. 2 or the image processing method shown in FIG. 3, it may be a physical device or an elastic computing host provided by a cloud computing platform. It may be implemented as a distributed cluster formed by multiple servers or terminal devices, or as a single server or a single terminal device.

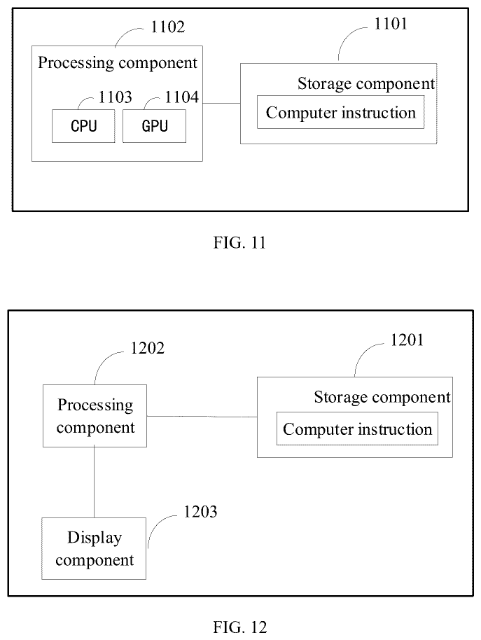

An embodiment of the present application further provides an electronic device, as shown in FIG. 12. The computing device may include a storage component 1201, a processing component 1202, and a display component 1203.

The storage component 1201 stores one or more computer instructions, where the one or more computer instructions are invoked and executed by the processing component 1202 to implement the image processing method of the embodiment shown in FIG. 4.

Of course, the computing device may further necessarily include other components, such as an input/output interface, and a communication component, etc. The input/output interface provides an interface between the processing component and a peripheral interface module. The peripheral interface module may be an output device, an input device, etc. The communication component is configured to facilitate wired or wireless communication between the computing device and other devices.

Here, the processing component may include one or more processors to execute the computer instructions to complete all or part of the steps in the above method. Of course, the processing component may also be one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic component implementations to perform the above method.

The storage component is configured to store data of various types to support operations on a terminal. The storage component may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The display component may be an electroluminescent (EL) element, a liquid crystal display or a micro-display with a similar structure, a direct retinal display or a similar laser scanning display.

The above electronic device may refer to a device that is used by a user and has functions required by the user, such as computing, Internet access, communication, etc. For example, the electronic device may be a mobile phone, a tablet, a personal computer, a wearable device, etc.

An embodiment of the present application further provides a computer-readable storage medium storing a computer program, where the computer program, when executed by a computer, is able to implement the image processing method of the embodiment shown in FIG. 1 or the image processing method of the embodiment shown in FIG. 2 or the image processing method of the embodiment shown in FIG. 3 or the image processing method of the embodiment shown in FIG. 4. The computer-readable medium may be included in the electronic device described in the above embodiments, and may also exist alone without being assembled into the electronic device.

An embodiment of the present application further provides a computer program product, which includes a computer program carried on a computer-readable storage medium, where the computer program, when executed by a computer, is able to implement the image processing method of the embodiment shown in FIG. 1 or the image processing method of the embodiment shown in FIG. 2 or the image processing method of the embodiment shown in FIG. 3 or the image processing method of the embodiment shown in FIG. 4. In such embodiment, the computer program may be downloaded and installed from a network, and/or installed from a removable medium. When the computer program is executed by a processor, the various functions defined in the present application are performed.

Those skilled in the art can clearly understand that, for the convenience and brevity of description, the specific working processes of the systems, apparatuses, and units described above can be found in the corresponding processes in the foregoing method embodiments, which will not be repeated here.

The apparatus embodiments described above are only illustrative. Here, the units described as separate components may or may not be physically separated, and the components displayed as units may or may not be physical units, that is, they may be located in one place or distributed to multiple network units. Part or all of the modules may be selected according to actual needs to achieve the purposes of the solutions of the embodiments. Those of ordinary skill in the art can understand and implement them without creative effort.

Through the description of the above implementations, those skilled in the art can clearly understand that each implementation may be implemented by means of software plus a necessary general hardware platform, and of course, it may also be implemented by hardware. Based on this understanding, the essence of the above technical solution or the part that contributes to the prior art may be embodied in the form of a software product. The computer software product may be stored in a computer-readable storage medium, such as a ROM (Read-Only Memory)/RAM (Random Access Memory), a magnetic disk, an optical disk, etc., including several instructions to make a computer device (which may be a personal computer, a server, or a network device, etc.) perform the methods described in the embodiments or some parts of the embodiments.

Finally, it should be noted that the above embodiments are only used to illustrate the technical solutions of the present application, not to limit them. Although the present application has been described in detail with reference to the foregoing embodiments, those of ordinary skill in the art should understand that they can still modify the technical solutions recorded in the foregoing embodiments, or equivalently replace some of the technical features; and these modifications or replacements do not make the essence of the corresponding technical solutions deviate from the spirit and scope of the technical solutions of the embodiments of the present application.

1. An image processing method, comprising:
determining at least one first image block in a first image frame whose content changes compared to a second image frame;
invoking a graphics processing unit to calculate a first feature of the at least one first image block;
determining a content type of the at least one first image block based on the first feature of the at least one first image block;
invoking the graphics processing unit to compress the at least one first image block according to compression manners corresponding to different content types;
generating update information for the first image frame based on the at least one first image block that is compressed, and transmitting the update information to a receiving end; wherein the update information is used to obtain the first image frame in combination with the second image frame.

2. The method according to claim 1, further comprising:
determining a plurality of first image blocks obtained by dividing the first image frame;
invoking the graphics processing unit to calculate second features of the plurality of first image blocks;
wherein the determining the at least one first image block in the first image frame whose content changes compared to the second image frame comprises:
determining the at least one first image block in the first image frame whose content changes compared to the second image frame, based on the second features.

3. The method according to claim 2, wherein the determining the plurality of first image blocks obtained by dividing the first image frame comprises:
invoking the graphics processing unit to capture the first image frame that is currently outputted; wherein the second image frame is a previous frame of the first image frame;
determining a division manner of the first image frame based on image resolution of the first image frame, and notifying the graphics processing unit of the division manner;
wherein the invoking the graphics processing unit to calculate the second features of the plurality of first image blocks comprises:
invoking the graphics processing unit to divide the first image frame into the plurality of first image blocks according to the division manner, and calculate the second features of the plurality of first image blocks.

4. The method according to claim 1, wherein the determining the at least one first image block in the first image frame whose content changes compared to the second image frame comprises:
for any first image block in the first image frame, comparing the first image block with a corresponding second image block at a same position in the second image frame;
in a case that content of the first image block is the same as content of the second image block, determining that the first image block is of a content-unchanged type;
in a case that the content of the first image block is different from the content of the second image block, if there is a second image block in the second image frame whose content is same as that of the first image block, determining that the first image block is of a position-updated type, and determining position change information of the first image block;
if there is no second image block in the second image frame whose content is same as that of the first image block, determining that the first image block is of a content-changed type;
determining at least one first image block of the content-changed type in the first image frame;
wherein the generating the update information for the first image frame based on the at least one first image block that is compressed comprises:
generating the update information for the first image frame based on identification information of an image block of the content-unchanged type, position change information of an image block of the position-updated type, and the at least one first image block that is compressed.

5. The image processing method according to claim 1,
wherein the first image frame is outputted by a cloud computing product, and the cloud computing product comprises a cloud desktop or a cloud application;
and wherein the transmitting the update information to the receiving end comprises transmitting the update information to a local client corresponding to the cloud computing product.

6. An image processing method, comprising:
determining a plurality of first image blocks obtained by dividing a first image frame;
invoking a graphics processing unit to calculate second features of the plurality of first image blocks;
determining at least one of the first image blocks in the first image frame whose content changes compared to a second image frame, based on the second features;
generating update information for the first image frame based on the at least one of the first image blocks, and transmitting the update information to a receiving end; wherein the update information is used to obtain the first image frame in combination with the second image frame.

7. The method according to claim 6, wherein the determining the plurality of first image blocks obtained by dividing the first image frame comprises:
invoking the graphics processing unit to capture the first image frame that is currently outputted; wherein the second image frame is a previous frame of the first image frame;
determining a division manner of the first image frame based on image resolution of the first image frame, and notifying the graphics processing unit of the division manner;
wherein the invoking the graphics processing unit to calculate the second features of the plurality of first image blocks comprises:
invoking the graphics processing unit to divide the first image frame into the plurality of first image blocks according to the division manner, and calculate the second features of the plurality of first image blocks in parallel.

8. The method according to claim 6, wherein the generating the update information for the first image frame based on the at least one of the first image blocks, and transmitting the update information to the receiving end, wherein the update information is used to obtain the first image frame in combination with the second image frame, comprises:
invoking the graphics processing unit to calculate a first feature of the at least one of the first image blocks;
determining a content type of the at least one of the first image blocks based on the first feature of the at least one of the first image blocks;
invoking the graphics processing unit to compress the at least one of the first image blocks according to compression manners corresponding to different content types;
generating the update information for the first image frame based on the at least one of the first image blocks that is compressed, and transmitting the update information to the receiving end;
wherein the update information is used to obtain the first image frame in combination with the second image frame.

9. The method according to claim 6, wherein the determining the at least one of the first image blocks in the first image frame whose content changes compared to the second image frame, based on the second features, comprises:
for any first image block in the first image frame, comparing a second feature of the first image block with a second feature corresponding to a second image block at a same position in the second image frame;
in a case that the second feature of the first image block is the same as the second feature corresponding to the second image block, determining that the first image block is of a content-unchanged type;
in a case that the second feature of the first image block is different from the second feature corresponding to the second image block, if there is a second image block in the second image frame whose second feature is same as that of the first image block, determining that the first image block is of a position-updated type, and determining position change information of the first image block;
if there is no second image block in the second image frame whose second feature is same as that of the first image block, determining that the first image block is of a content-changed type;
determining at least one first image block of the content-changed type in the first image frame;
wherein the generating the update information for the first image frame based on the at least one of the first image blocks comprises:
generating the update information for the first image frame based on identification information of an image block of the content-unchanged type, position change information of an image block of the position-updated type, and the at least one first image block.

10. An image processing method, comprising:
calculating a first feature of at least one first image block in a first image frame based on a first invocation instruction; wherein the first invocation instruction is sent by a sending end after the sending end determines the at least one first image block in the first image frame whose content changes compared to a second image frame;
feeding back the first feature of the at least one first image block to the sending end; wherein the first feature of the at least one first image block is used to determine a content type of the at least one first image block, and generate a corresponding compression instruction;
compressing the at least one first image block according to a compression manner indicated by the compression instruction;
sending the at least one first image block that is compressed to the sending end; wherein the at least one first image block that is compressed is used to generate update information for the first image frame and transmit the update information to a receiving end, and the update information is used to obtain the first image frame in combination with the second image frame.

11. The method according to claim 10, further comprising:
calculating second features of a plurality of first image blocks obtained by dividing the first image frame, based on a second invocation instruction;
feeding back the second features of the plurality of first image blocks to the sending end; wherein the second features of the plurality of first image blocks are used to determine the at least one first image block in the first image frame whose content changes compared to the second image frame.

12. The image processing method according to claim 10, wherein
the method is applied to a graphics processing unit configured in a physical device running a cloud computing product, and the cloud computing product comprises a cloud desktop or a cloud application;
wherein the calculating the first feature of the at least one first image block in the first image frame based on the first invocation instruction comprises calculating the first feature of the at least one first image block in the first image frame outputted by the cloud computing product, based on the first invocation instruction; wherein the first invocation instruction is sent by the cloud computing product after the cloud computing product determines the at least one first image block in the first image frame whose content changes compared to the second image frame;
wherein the sending the at least one first image block that is compressed to the sending end comprises sending the at least one image block that is compressed to the cloud computing product;
wherein the at least one first image block that is compressed is used to generate the update information for the first image frame and transmit the update information to a local receiving end corresponding to the cloud computing product.

13. A computing device, comprising a processing component and a storage component; wherein the processing component comprises a central processing unit and a graphics processing unit;
the storage component stores one or more computer instructions;
the central processing unit is configured to invoke and execute at least one computer instruction to implement the image processing method according to claim 1;
the graphics processing unit is configured to invoke and execute at least one computer instruction to:
calculate the first feature of the at least one first image block in the first image frame based on a first invocation instruction; wherein the first invocation instruction is sent by the central processing unit after the central processing unit determines the at least one first image block in the first image frame whose content changes compared to the second image frame;
feed back the first feature of the at least one first image block to the central processing unit; wherein the first feature of the at least one first image block is used to generate a corresponding compression instruction;
compress the at least one first image block according to a compression manner indicated by the compression instruction; and
send the at least one first image block that is compressed to the central processing unit.

14. A non-transitory computer storage medium, storing a computer program, wherein when the computer program is executed by a computer, the image processing method according to claim 1 is implemented.

15. The computing device according to claim 13, wherein the central processing unit is further configured to invoke and execute at least one computer instruction to: determine a plurality of first image blocks obtained by dividing the first image frame, and send a second invocation instruction to the graphics processing unit;
wherein the graphics processing unit is further configured to invoke and execute at least one computer instruction to: calculate the second features of the plurality of first image blocks obtained by dividing the first image frame, based on the second invocation instruction; and feed back the second features of the plurality of first image blocks to the central processing unit;
and wherein the central processing unit is specifically configured to invoke and execute at least one computer instruction to determine the at least one first image block in the first image frame whose content changes compared to the second image frame, based on the second features.

16. The computing device according to claim 15, wherein the central processing unit is specifically configured to invoke and execute at least one computer instruction to:
invoke the graphics processing unit to capture the first image frame that is currently outputted; wherein the second image frame is a previous frame of the first image frame; and
determine a division manner of the first image frame based on image resolution of the first image frame, and notify the graphics processing unit of the division manner;
and the central processing unit is specifically configured to invoke and execute at least one computer instruction to:
invoke the graphics processing unit to divide the first image frame into the plurality of first image blocks according to the division manner, and calculate the second features of the plurality of first image blocks.

17. A computing device, comprising a processing component and a storage component; wherein the processing component comprises a central processing unit and a graphics processing unit;
the storage component stores one or more computer instructions;
the central processing unit is configured to invoke and execute at least one computer instruction to implement the image processing method according to claim 6;
the graphics processing unit is configured to invoke and execute at least one computer instruction to:
calculate the second features of the plurality of first image blocks obtained by dividing the first image frame, based on a second invocation instruction sent by the central processing unit; and
feed back the second features of the plurality of first image blocks to the central processing unit.

18. The computing device according to claim 17, wherein the central processing unit is specifically configured to invoke and execute at least one computer instruction to:
invoke the graphics processing unit to capture the first image frame that is currently outputted; wherein the second image frame is a previous frame of the first image frame; and
determine a division manner of the first image frame based on image resolution of the first image frame, and notify the graphics processing unit of the division manner;
and the central processing unit is specifically configured to invoke and execute at least one computer instruction to:
invoke the graphics processing unit to divide the first image frame into the plurality of first image blocks according to the division manner, and calculate the second features of the plurality of first image blocks in parallel.

19. A non-transitory computer storage medium, storing a computer program, wherein when the computer program is executed by a computer, the image processing method according to claim 6 is implemented.

20. A non-transitory computer storage medium, storing a computer program, wherein when the computer program is executed by a computer, the image processing method according to claim 10 is implemented.
